(19) United States
(12) Patent Application Publication
(10) Pub. No.: US 2009/0322860 A1
(43) Pub. Date: Dec. 31, 2009

(54) SYSTEM AND METHOD FOR MODEL FITTING AND REGISTRATION OF OBJECTS FOR 2D-TO-3D CONVERSION

(76) Inventors: Dong-Qing Zhang, Burbank, CA (US); Ana Belen Benitez, Los Angeles, CA (US); James Arthur Fancher, Los Angeles, CA (US)

Correspondence Address: Robert D. Shedd, Patent Operations;THOMSON Licensing LLC, P.O. Box 5312, Princeton, NJ, 08543-5312, US

(21) Appl. No.: 12/514,636

(22) PCT Filed: Nov. 17, 2006
(86) PCT No.: PCT/US06/44834

§ 371 Date: May 13, 2009

(51) Int. Cl. H04N 13/02

(52) U.S. Cl. 348/46

(57) ABSTRACT

A system and method is provided for model fitting and registration of objects for 2D-to-3D conversion of images to create stereoscopic images. The system and method of the present disclosure provides for acquiring at least one two-dimensional (2D) image, identifying at least one object of the at least one 2D image, selecting at least one 3D model from a plurality of predetermined 3D models, the selected 3D model relating to the identified at least one object, registering the selected 3D model to the identified at least one object, and creating a complementary image by projecting the selected 3D model onto an image plane different than the image plane of the at least one 2D image. The registering process can be implemented using geometric approaches or photometric approaches.

### TECHNICAL FIELD OF THE INVENTION

The present disclosure generally relates to computer graphics processing and display systems, and more particularly, to a system and method for model fitting and registration of objects for 2D-to-3D conversion.

### BACKGROUND OF THE INVENTION

2D-to-3D conversion is a process to convert existing two-dimensional (2D) films into three-dimensional (3D) stereoscopic films. 3D stereoscopic films reproduce moving images in such a way that depth is perceived and experienced by a viewer, for example, while viewing such a film with passive or active 3D glasses. There have been significant interests from major film studios in converting legacy films into 3D stereoscopic films.

Stereoscopic imaging is the process of visually combining at least two images of a scene, taken from slightly different viewpoints, to produce the illusion of three-dimensional depth. This technique relies on the fact that human eyes are spaced some distance apart and do not, therefore, view exactly the same scene. By providing each eye with an image from a different perspective, the viewer's eyes are tricked into perceiving depth. Typically, where two distinct perspectives are provided, the component images are referred to as the “left” and “right” images, also know as a reference image and complementary image, respectively. However, those skilled in the art will recognize that more than two viewpoints may be combined to form a stereoscopic image.

Stereoscopic images may be produced by a computer using a variety of techniques. For example, the “anaglyph” method uses color to encode the left and right components of a stereoscopic image. Thereafter, a viewer wears a special pair of glasses that filters light such that each eye perceives only one of the views.

Similarly, page-flipped stereoscopic imaging is a technique for rapidly switching a display between the right and left views of an image. Again, the viewer wears a special pair of eyeglasses that contains high-speed electronic shutters, typically made with liquid crystal material, which open and close in sync with the images on the display. As in the case of anaglyphs, each eye perceives only one of the component images.

Other stereoscopic imaging techniques have been recently developed that do not require special eyeglasses or headgear. For example, lenticular imaging partitions two or more disparate image views into thin slices and interleaves the slices to form a single image. The interleaved image is then positioned behind a lenticular lens that reconstructs the disparate views such that each eye perceives a different view. Some lenticular displays are implemented by a lenticular lens positioned over a conventional LCD display, as commonly found on computer laptops.

Another stereoscopic imaging technique involves shifting regions of an input image to create a complementary image. Such techniques have been utilized in a manual 2D-to-3D film conversion system developed by a company called In-Three, Inc. of Westlake Village, Calif. The 2D-to-3D conversion system is described in U.S. Pat. No. 6,208,348 issued on Mar. 27, 2001 to Kaye. Although referred to as a 3D system, the process is actually 2D because it does not convert a 2D image back into a 3D scene, but rather manipulates the 2D input image to create the right-eye image. FIG. 1 illustrates the workflow developed by the process disclosed in U.S. Pat. No. 6,208,348, where FIG. 1 originally appeared as FIG. 5 in U.S. Pat. No. 6,208,348. The process can be described as the following: for an input image, regions 2, 4, 6 are first outlined manually. An operator then shifts each region to create stereo disparity, e.g., regions 8, 10, 12. The depth of each region can be seen by viewing its 3D playback in another display using 3D glasses. The operator adjusts the shifting distance of the region until an optimal depth is achieved. However, the 2D-to-3D conversion is achieved mostly manually by shifting the regions in the input 2D images to create the complementary right-eye images. The process is very inefficient and requires enormous human intervention.

### SUMMARY

The present disclosure provides system and method for model fitting and registration of objects for 2D-to-3D conversion of images to create stereoscopic images. The system includes a database that stores a variety of 3D models of real-world objects. For a first 2D input image (e.g., the left eye image or reference image), regions to be converted to 3D are identified or outlined by a system operator or automatic detection algorithm. For each region, the system selects a stored 3D model from the database and registers the selected 3D model so the projection of the 3D model matches the image content within the identified region in an optimal way. The matching process can be implemented using geometric approaches or photometric approaches. After a 3D position and pose of the 3D object has been computed for the first 2D image via the registration process, a second image (e.g., the right eye image or complementary image) is created by projecting the 3D scene, which includes the registered 3D objects with deformed texture, onto another imaging plane with a different camera view angle.

According to one aspect of the present disclosure, a three-dimensional (3D) conversion method for creating stereoscopic images is provided. The method includes acquiring at least one two-dimensional (2D) image, identifying at least one object of the at least one 2D image, selecting at least one 3D model from a plurality of predetermined 3D models, the selected 3D model relating to the identified at least one object, registering the selected 3D model to the identified at least one object, and creating a complementary image by projecting the selected 3D model onto an image plane different than the image plane of the at least one 2D image.

In another aspect, registering includes matching a projected 2D contour of the selected 3D model to a contour of the at least one object.

In a further aspect of the present disclosure, registering includes matching at least one photometric feature of the selected 3D model to at least one photometric feature of the at least one object.

In another aspect of the present disclosure, a system for three-dimensional (3D) conversion of objects from two-dimensional (2D) images includes a post-processing device configured for creating a complementary image from at least one 2D image, the post-processing device includes an object detector configured for identifying at least one object in at least one 2D image, an object matcher configured for registering at least one 3D model to the identified at least one object, an object renderer configured for projecting the at least one 3D model into a scene, and a reconstruction module configured for selecting the at least one 3D model from a plurality of predetermined 3D models, the selected at least one 3D model relating to the identified at least one object, and creating a complementary image by projecting the selected 3D model onto an image plane different than the image plane of the at least one 2D image.

In yet a further aspect of the present disclosure, a program storage device readable by a machine, tangibly embodying a program of instructions executable by the machine to perform method steps for creating stereoscopic images from a two-dimensional (2D) image is provided, the method including acquiring at least one two-dimensional (2D) image, identifying at least one object of the at least one 2D image, selecting at least one 3D model from a plurality of predetermined 3D models, the selected 3D model relating to the identified at least one object, registering the selected 3D model to the identified at least one object, and creating a complementary image by projecting the selected 3D model onto an image plane different than the image plane of the at least one 2D image.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 illustrates a prior art technique for creating a right-eye or complementary image from an input image;

FIG. 2 is an exemplary illustration of a system for two-dimensional (2D) to three-dimensional (3D) conversion of images for creating stereoscopic images according to an aspect of the present disclosure;

FIG. 3 is a flow diagram of an exemplary method for converting two-dimensional (2D) images to three-dimensional (3D) images for creating stereoscopic images according to an aspect of the present disclosure;

FIG. 4 illustrates a geometric configuration of a three-dimensional (3D) model according to an aspect of the present disclosure;

FIG. 5 illustrates a function representation of a contour according to an aspect of the present disclosure; and

FIG. 6 illustrates a matching function for multiple contours according to an aspect of the present disclosure.

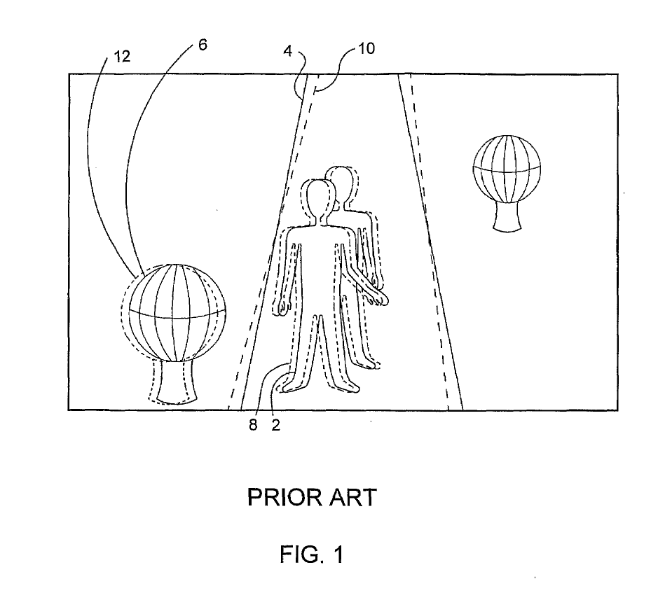

It should be understood that the drawing(s) is for purposes of illustrating the concepts of the invention and is not necessarily the only possible configuration for illustrating the invention.

### DETAILED DESCRIPTION OF PREFERRED EMBODIMENTS

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure deals with the problem of creating 3D geometry from 2D images. The problem arises in various film production applications, including visual effects (VXF), 2D film to 3D film conversion, among others. Previous systems for 2D-to-3D conversion are realized by creating a complimentary image (also known as a right-eye image) by shifting selected regions in the input image, therefore, creating stereo disparity for 3D playback. The process is very inefficient, and it is difficult to convert regions of images to 3D surfaces if the surfaces are curved rather than flat.

To overcome the limitations of manual 2D-to-3D conversion, the present disclosure provides techniques to recreate a 3D scene by placing 3D solid objects, pre-stored in a 3D object repository, in a 3D space so that the 2D projections of the objects match the content in the original 2D images. A right-eye image (or complementary image) therefore can be created by projecting the 3D scene with a different camera viewing angle. The techniques of the present disclosure will dramatically increase the efficiency of 2D-to-3D conversion by avoiding region-shifting based techniques.

The system and method of the present disclosure provide a 3D-based technique for 2D-to-3D conversion of images to create stereoscopic images. The stereoscopic images can then be employed in further processes to create 3D stereoscopic films. The system includes a database that stores a variety of 3D models of real-world objects. For a first 2D input image (e.g., a left eye image or reference image), regions to be converted to 3D are identified or outlined by a system operator or automatic detection algorithm. For each region, the system selects a stored 3D model from the database and registers the selected 3D model so the projection of the 3D model matches the image content within the identified region in an optimal way. The matching process can be implemented using geometric approaches or photometric approaches. After a 3D position and pose of the 3D object has been computed for the input 2D image via the registration process, a second image (e.g., a right eye image or complementary image) is created by projecting the 3D scene, which now includes the registered 3D objects with deformed texture, onto another imaging plane with a different camera view angle.

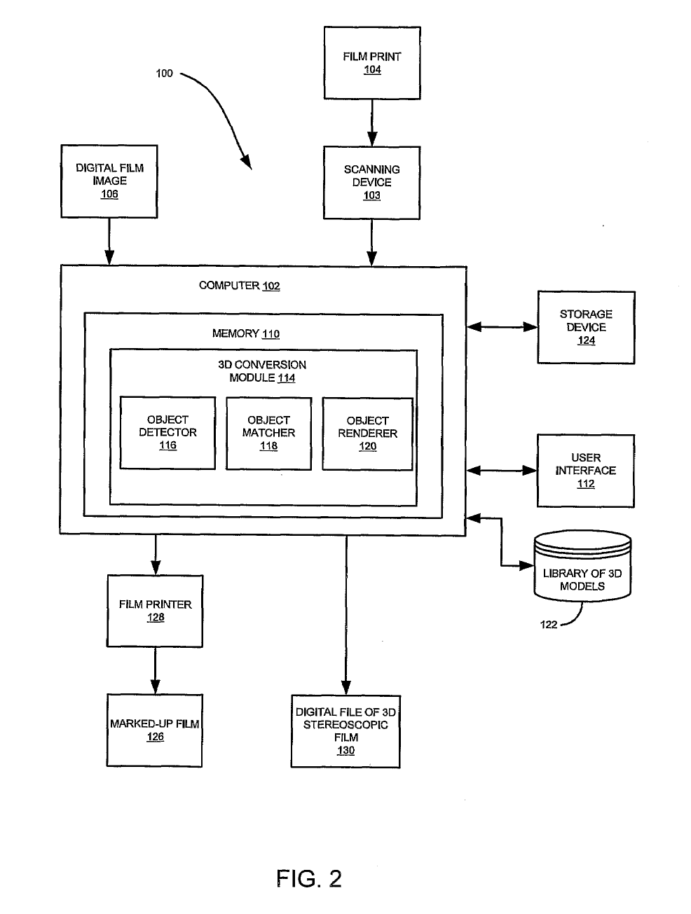

Referring now to the Figures, exemplary system components according to an embodiment of the present disclosure are shown in FIG. 2. A scanning device 103 may be provided for scanning film prints 104, e.g., camera-original film negatives, into a digital format, e.g. Cineon-format or SMPTE DPX files. The scanning device 103 may comprise, e.g., a telecine or any device that will generate a video output from film such as, e.g., an Arri LocPro™ with video output. Alternatively, files from the post production process or digital cinema 106 (e.g., files already in computer-readable form) can be used directly. Potential sources of computer-readable files, include, but are not limited to AVID™ editors, DPX files, D5 tapes, and the like.

Scanned film prints are input to a post-processing device 102, e.g., a computer. The computer 102 is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In addition, various other peripheral devices may be connected to the computer platform by various interfaces and bus structures, such a parallel port, serial port or universal serial bus (USB). Other peripheral devices may include additional storage devices 124 and a printer 128. The printer 128 may be employed for printing a revised version of the film 126, e.g., a stereoscopic version of the film, wherein a scene or a plurality of scenes may have been altered or replaced using 3D modeled objects as a result of the techniques described below.

Alternatively, files/film prints already in computer-readable form 106 (e.g., digital cinema, which for example, may be stored on external hard drive 124) may be directly input into the computer 102. Note that the term “film” used herein may refer to either film prints or digital cinema.

A software program includes a three-dimensional (3D) conversion module 114 stored in the memory 110 for converting two-dimensional (2D) images to three-dimensional (3D) images for creating stereoscopic images. The 3D conversion module 114 includes an object detector 116 for identifying objects or regions in 2D images. The object detector 116 identifies objects either by manually outlining image regions containing objects by image editing software or by isolating image regions containing objects with automatic detection algorithms. The 3D conversion module 114 also includes an object matcher 118 for matching and registering 3D models of objects to 2D objects. The object matcher 118 will interact with a library of 3D models 122 as will be described below. The library of 3D models 122 will include a plurality of 3D object models where each object model relates to a predefined object. For example, one of the predetermined 3D models may be used to model a “building” object or a “computer monitor” object. The parameters of each 3D model are predetermined and saved in the database 122 along with the 3D model. An object renderer 120 is provided for rendering the 3D models into a 3D scene to create a complementary image. This is realized by rasterization process or more advanced techniques, such as ray tracing or photon mapping.

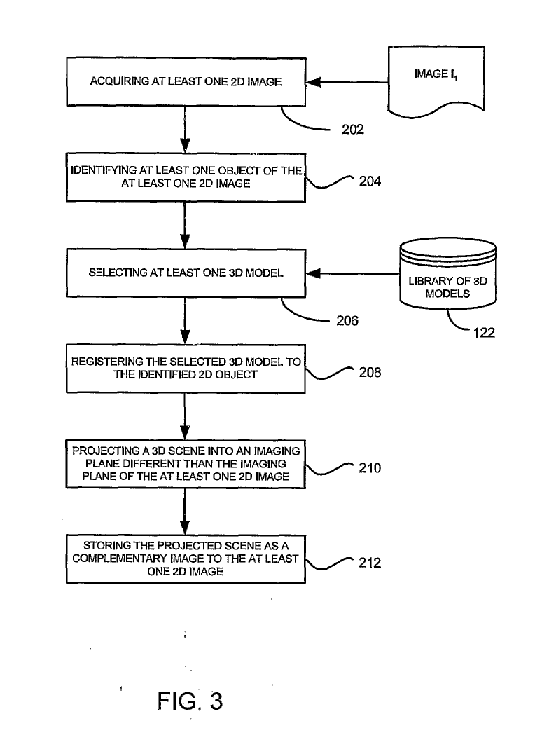

FIG. 3 is a flow diagram of an exemplary method for converting two-dimensional (2D) images to three-dimensional (3D) images for creating stereoscopic images according to an aspect of the present disclosure. Initially, the post-processing device 102 acquires at least one two-dimensional (2D) image, e.g., a reference or left-eye image (step 202). The post-processing device 102 acquires at least one 2D image by obtaining the digital master video file in a computer-readable format, as described above. The digital video file may be acquired by capturing a temporal sequence of video images with a digital video camera. Alternatively, the video sequence may be captured by a conventional film-type camera. In this scenario, the film is scanned via scanning device 103. The camera will acquire 2D images while moving either the object in a scene or the camera. The camera will acquire multiple viewpoints of the scene.

It is to be appreciated that whether the film is scanned or already in digital format, the digital file of the film will include indications or information on locations of the frames, e.g., a frame number, time from start of the film, etc. Each frame of the digital video file will include one image, e.g., I₁, I₂, . . . Iₙ.

In step 204, an object in the 2D image is identified. Using the object detector 116, an object may be manually selected by a user using image editing tools, or alternatively, the object may be automatically detected using image detection algorithms, e.g., segmentation algorithms. It is to be appreciated that a plurality of objects may be identified in the 2D image. Once the object is identified, at least one of the plurality of predetermined 3D object models is selected, at step 206, from the library of predetermined 3D models 122. It is to be appreciated that the selecting of the 3D object model may be performed manually by an operator of the system or automatically by a selection algorithm. The selected 3D model will relate to the identified object in some manner, e.g., a 3D model of a person will be selected for an identified person object, a 3D model of a building will be selected for an identified building object, etc.

Next, in step 208, the selected 3D object model is registered to the identified object. A contour-based approach and photometric approach for the registration process will now be described.

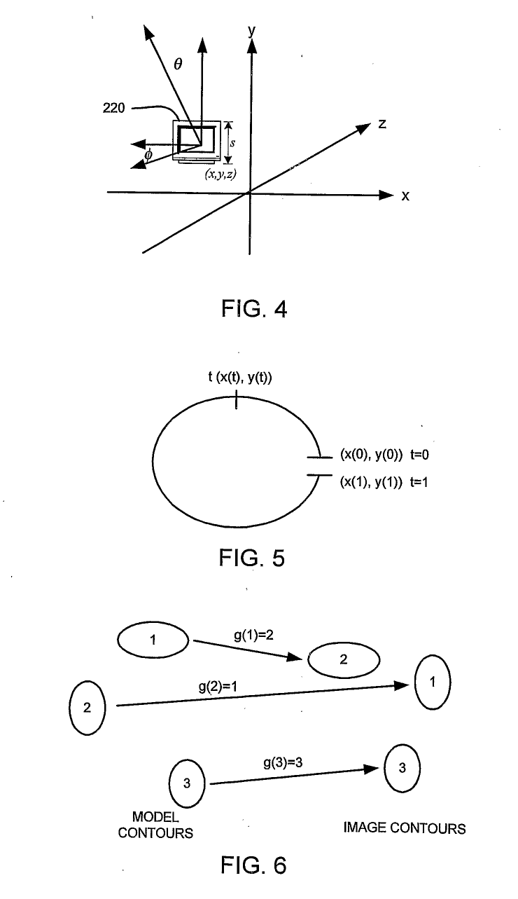

The contour-based registration technique matches the projected 2D contour (i.e., occluding contour) of the selected 3D object to the outlined/detected contour of the identified object in the 2D image. The occluding contour of the 3D object is the boundary of the 2D region of the object after the 3D object is projected to the 2D plane. Assuming the free parameters of the 3D model, e.g., computer monitor 220, include the following: 3D location (x,y,z), 3D pose ((θ,φ) and scale s (as illustrated in FIG. 4); the controlling parameter of the 3D model is Φ=(x,y,z,θ,φ,s) which defines the 3D configuration of the object. The contour of the 3D model can then be defined as a vector function as follows:

f(t)=[x(t), y(t)], tε[0,1] (1)

This function representation of a contour is illustrated in FIG. 5. Since the occluding contour depends on the 3D configuration of an object, the contour function depends on Φ and can be written as

fₘ(t|Φ)=[xₘ(t|Φ), yₘ(t|Φ)], tε[0,1] (2)

where, m means 3D model. The contour of the outlined region can be represented as a similar function

f_{d}(t)=[x_{d}(t), y_{d}(t)], tε[0,1] (3)

which is a non-parametric contour. Then, the best parameter Φ is found by minimizing the cost function C(Φ) with respect to the 3D configuration as follows:

C(Φ)=∫₀¹[(xₘ(t)−x_{d}(t|Φ))²+(yₘ(t)−y_{d}(t|Φ)]²dt (4)

However, the above minimization is quite difficult to compute, because the geometry transform from 3D object to 2D region is complicated and the cost function may be not differentiable, and therefore, the closed form solution of ( ) may be difficult to achieve. One approach to facilitate the computation is to use a nondeterministic sampling technique (e.g., a Monte Carlo technique) to randomly sample the parameters in the parameter space until a desired error is achieved, e.g., a predetermined threshold value.

The above describes the estimation of the 3D configuration based on matching a single contour. However, if there are multiple objects, or there are holes in the identified objects, multiple occluding contours after 2D projection may occur. Furthermore, the object detector 188 may have identified multiple outlined regions in the 2D images. In these cases, many-to-many contour matching will be processed. Assuming that the model contours (e.g., 2D projection of 3D models) are represented as fₘ_{₁}, fₘ_{₂}, . . . fₘ_{ᵢ} . . . , fₘ_{_{N}}, and the image contours (e.g., the contours in the 2D image) are represented as f_{d}_{₁}, f_{d}_{₂}, . . . f_{d}_{ⱼ} . . . , f_{d}_{_{M}}, where i,j are an integer index to identify the contours. The correspondence between contours can be represented as a function g(.), which maps the index of the model contours to the index of the image contours as illustrated in FIG. 6. The best contour correspondence and the best 3D configuration is then determined to minimize the overall cost function, calculated as follows:

$$C ( Φ , g ) + {\sum }_{i ∈ [ 1 , N ]} {C}_{i , g ( i )} ( Φ ) \qquad ( 5 )$$

where C_{i,g(i)}(Φ) is the cost function defined in Eq. (4) between the ith model contour and its matched image contour indexed as g(i) where g(.) is the correspondence function.

A complimentary approach for registration is that of using photometric features of the selected regions of the 2D image. Examples of photometric features include color features, texture features among others. For photometric registration, the 3D models stored in the database will be attached with surface texture. Feature extraction techniques can be applied to extract informative attributes, including but not limited to color histogram or moment features, to describe the pose or position of the object. The features then can be used to estimate the geometric parameters of the 3D models or to refine the geometric parameters that have been estimated during geometric approaches of registration.

Assuming the projected image of the selected 3D model is Iₘ(Φ), the projected image is a function of the 3D pose parameter of the 3D model. The texture feature extracted from the image Iₘ(Φ) is Tₘ(Φ), and if the image within the selected region is I_{d}, the texture feature is T_{d}. Similar to above, a least-square cost function is defined as follows:

$${C}^{′} ( Φ ) = {‖ {T}_{m} ( Φ ) - {T}_{d} ‖}^{2} = {\sum }_{i = 1}^{N} {( {T}_{m i} ( Φ ) - {T}_{di} )}^{2} \qquad ( 6 )$$

However, as described above, there may be no closed-form solution for the above minimization problem, and therefore, the minimization could be realized by Monte Carlo techniques.

In another embodiment of the present disclosure, the photometric approach can be combined with the contour-based approach. To achieve this, a joint cost function is defined which combines the two cost function linearly:

C(Φ)+λC′(Φ) (7)

where λ is a weighting factor determining the contribution of the contour-based and photometric methods. It is to be appreciated that the weighting factor may be applied to either method.

Once all of the objects identified in the scene have been converted into 3D space, the complementary image (e.g., the right-eye image) is created by rendering the 3D scene including converted 3D objects and a background plate into another imaging plane (step 210), different than the imaging plane of the input 2D image, which is determined by a virtual right camera. The rendering may be realized by a rasterization process as in the standard graphics card pipeline, or by more advanced techniques such as ray tracing used in the professional post-production workflow. The position of the new imaging plane is determined by the position and view angle of the virtual right camera. The setting of the position and view angle of the virtual right camera (e.g., the camera simulated in the computer or post-processing device) should result in an imaging plane that is parallel to the imaging plane of the left camera that yields the input image. In one embodiment, this can be achieved by making a minor adjustment to the position and view angle of the virtual camera and getting feedback by viewing the resulting 3D playback on a display device. The position and view angle of the right camera is adjusted so that the created stereoscopic image can be viewed in the most comfortable way by the viewers.

The projected scene is then stored, in step 212, as a complementary image, e.g., the right-eye image, to the input image, e.g., the left-eye image. The complementary image will be associated to the input image in any conventional manner so they may be retrieved together at a later point in time. The complementary image may be saved with the input, or reference, image in a digital file 130 creating a stereoscopic film. The digital file 130 may be stored in storage device 124 for later retrieval, e.g., to print a stereoscopic version of the original film.

Although the embodiment which incorporates the teachings of the present disclosure has been shown and described in detail herein, those skilled in the art can readily devise many other varied embodiments that still incorporate these teachings. Having described preferred embodiments for a system and method for model fitting and registration of objects for 2D-to-3D conversion (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the disclosure as outlined by the appended claims.

1. A three-dimensional conversion method for creating stereoscopic images comprising:
acquiring at least one two-dimensional image;
identifying at least one object of the at least one two-dimensional image;
selecting at least one three-dimensional model from a plurality of predetermined three-dimensional models, the selected three-dimensional model relating to the identified at least one object;
registering the selected three-dimensional model to the identified at least one object; and
creating a complementary image by projecting the selected three-dimensional model onto an image plane different than the image plane of the at least one two-dimensional image.

2. The method as in claim 1, wherein the identifying step includes detecting a contour of the at least one object.

3. The method as in claim 2, wherein the registering step includes matching a projected two-dimensional contour of the selected three-dimensional model to the contour of the at least one object.

4. The method as in claim 3, wherein the matching step includes calculating a pose, position and scale of the selected three-dimensional model to match a pose, position and scale of the identified at least one object.

5. The method as in claim 4, wherein the matching step includes minimizing a difference between the pose, position and scale of the at least one object and the pose, position and scale of the selected three-dimensional model.

6. The method as in claim 5, wherein the minimizing step includes applying a nondeterministic sampling technique to ascertain the minimized difference.

7. The method as in claim 1, wherein the registering step includes matching at least one photometric feature of the selected three-dimensional model to at least one photometric feature of the at least one object.

8. The method as in claim 7, wherein the at least one photometric feature is surface texture.

9. The method as in claim 7, wherein a pose and position of the at least one object is determined by applying a feature extraction function to the at least one object.

10. The method as in claim 9, wherein the matching step includes minimizing a difference between the pose and position of the at least one object and the pose and position of the selected three-dimensional model.

11. The method as in claim 10, wherein the minimizing step includes applying a nondeterministic sampling technique to ascertain the minimized difference.

12. The method as in claim 1, wherein the registering step further comprises:
matching a projected two-dimensional contour of the selected three-dimensional model to a contour of the at least one object;
minimizing a difference between the matched contours;
matching at least one photometric feature of the selected three-dimensional model to at least one photometric feature of the at least one object; and
minimizing a difference between the at least one photometric features.

13. The method as in claim 12, further comprising applying a weighting factor to at least one of the minimized difference between the matched contours and the minimized difference between the at least one photometric features.

14. A system for three-dimensional conversion of objects from two-dimensional images, the system comprising:
a post-processing device configured for creating a complementary image from at least one two-dimensional image, the post-processing device including:
an object detector configured for identifying at least one object in at least one two-dimensional image;
an object matcher configured for registering at least one three-dimensional model to the identified at least one object;
an object renderer configured for projecting the at least one three-dimensional model into a scene; and
a reconstruction module configured for selecting the at least one three-dimensional model from a plurality of predetermined three-dimensional models, the selected at least one three-dimensional model relating to the identified at least one object, and creating a complementary image by projecting the selected three-dimensional model onto an image plane different than the image plane of the at least one two-dimensional image.

15. The system as in claim 14, wherein the object matcher is configured for detecting a contour of the at least one object.

16. The system as in claim 15, wherein the object matcher is configured for matching a projected two-dimensional contour of the selected three-dimensional model to the contour of the at least one object.

17. The system as in claim 16, wherein the object matcher is configured for calculating a pose, position and scale of the selected three-dimensional model to match a pose, position and scale of the identified at least one object.

18. The system as in claim 17, wherein the object matcher is configured for minimizing a difference between the pose, position and scale of the at least one object and the pose, position and scale of the selected three-dimensional model.

19. The system as in claim 18, wherein the object matcher is configured for applying a nondeterministic sampling technique to ascertain the minimized difference.

20. The system as in claim 14, wherein the object matcher is configured for matching at least one photometric feature of the selected three-dimensional model to at least one photometric feature of the at least one object.

21. The system as in claim 20, wherein the at least one photometric feature is surface texture.

22. The system as in claim 20, wherein a pose and position of the at least one object is determined by applying a feature extraction function to the at least one object.

23. The system as in claim 22, wherein the object matcher is configured for minimizing a difference between the pose and position of the at least one object and the pose and position of the selected three-dimensional model.

24. The system as in claim 23, wherein the object matcher is configured for applying a nondeterministic sampling technique to ascertain the minimized difference.

25. The system as in claim 14, wherein the object matcher is configured for matching a projected two-dimensional contour of the selected three-dimensional model to a contour of the at least one object, minimizing a difference between the matched contours, matching at least one photometric feature of the selected three-dimensional model to at least one photometric feature of the at least one object, and minimizing a difference between the at least one photometric features.

26. The system as in claim 25, wherein the object matcher is configured for applying a weighting factor to at least one of the minimized difference between the matched contours and the minimized difference between the at least one photometric features.

27. A program storage device readable by a machine, tangibly embodying a program of instructions executable by the machine to perform method steps for creating stereoscopic images from a two-dimensional image, the method comprising:
acquiring at least one two-dimensional image;
identifying at least one object of the at least one two-dimensional image;
selecting at least one three-dimensional model from a plurality of predetermined three-dimensional models, the selected three-dimensional model relating to the identified at least one object;
registering the selected three-dimensional model to the identified at least one object; and
creating a complementary image by projecting the selected three-dimensional model onto an image plane different than the image plane of the at least one two-dimensional image.
